(19) United States
(12) Patent Application Publication
(10) Pub. No.: US 2026/0252692 A1
(43) Pub. Date: Aug. 27, 2026

(54) MALWARE SIGNATURE DETECTION

(71) Applicant: Recorded Future, Inc., Somerville, MA (US)

(72) Inventors: Daniel Gillblad, Gothenburg (SE); Anders Hanson, Gothenburg (SE); Jan Sparud, Gothenburg (SE)

(21) Appl. No.: 19/452,928

(22) Filed: Jan. 20, 2026

Related U.S. Application Data
(60) Provisional application No. 63/751,197, filed on Jan. 29, 2025.

(51) Int. Cl. G06F 21/56; G06F 21/55

(52) U.S. Cl. CPC G06F 21/564; G06F 21/554

(57) ABSTRACT

Disclosed, in one general aspect, is a computer network security threat monitoring system that includes storage to receive and store executable malware binary files and commonly used binary files certified as malware free. It also includes a search tool to accesses the malware binary storage and select a subset of the stored executable malware binary files for characterization. An iterative pattern detection engine iteratively derives a set of malware identification patterns that are found in successive portions of the selected subset of the stored executable binary files but not in the stored benign executable binary files. An optimized pattern selection engine selects an optimized subset of these malware identification patterns, with the patterns in the optimized subset together matching every one of the selected subset of the stored executable binary files but none of the stored benign executable binary files.

### FIELD OF THE INVENTION

This invention relates to cybersecurity systems and methods, including automated systems and methods for deriving sets of malware file signatures to use in protecting computer systems.

### BACKGROUND OF THE INVENTION

Detecting the presence of malware files is important in protecting networked computer systems. This can be made more difficult by deliberately created variations and obfuscations that are often introduced within malware families. YARA rules, for example, are widely used in cybersecurity for identifying and classifying malware binary files. These rules include conditions that are triggered by patterns in a data stream, such as in a firewall. YARA rules have traditionally been handcrafted by experts, which can require substantial skill and time.

### SUMMARY OF THE INVENTION

In one general aspect, the invention features a computer network security threat monitoring system that includes storage to receive and store executable malware binary files and commonly used binary files certified as malware free. It also includes a search tool to accesses the malware binary storage and select a subset of the stored executable malware binary files for characterization. An iterative pattern detection engine iteratively derives a set of malware identification patterns that are found in successive portions of the selected subset of the stored executable binary files but not in the stored benign executable binary files. An optimized pattern selection engine selects an optimized subset of these malware identification patterns, with the patterns in the optimized subset together matching every one of the selected subset of the stored executable binary files but none of the stored benign executable binary files.

In preferred embodiments, the iterative pattern detection engine can be operative to iteratively detect the patterns by first detecting patterns in one of the portions of the subset (m) of the malware files and then applying the detected patterns in the subset of malware files to remaining malware files in the selected subset of the malware files. The iterative pattern detection engine can be operative to find patterns that only match an iteratively adjustable number (k) of the malware binary files. The iterative pattern detection engine can be operative to iteratively detect the patterns by first detecting patterns in a subset of the benign files and then applying the detected patterns to remaining benign files. The iterative pattern detection engine can be operative to iteratively derive the set of malware identification patterns based on generalized suffix arrays. The search tool can include a user engine including selection controls allowing the user to specify a search query. The system can further include iteration parameter controls responsive to user input to specify iteration parameters for the iterative pattern detection engine. The search tool can be operative to generate queries that match dynamic and static features of the malware binary files. The search tool can also be operative to generate queries that match a source of the malware binary files. The system can further include an automatic iteration parameter control that is operative to specify iteration parameters for the iterative pattern detection engine based at least on a measure of size of the selected subset of malware executable binary files. The system can further include a rule formatter to convert the optimized subset of the malware identification patterns into rules for deployment to endpoint protection systems. The rule formatter can be a YARA rule formatter. The optimized pattern selection engine can be operative to iteratively optimize pattern selection using a bipartite graph. The optimized pattern selection engine can employ cost-effectiveness heuristics to optimize pattern selection. The cost-effectiveness heuristics can include at least measures of pattern length, entropy, and character content. The system can further include an unpacking engine operative to unpack the stored malware binaries before processing by the iterative pattern detection engine. The system can further include a rule distribution subsystem operative to distribute the optimized subset of the malware identification patterns selected by the optimized pattern selection engine.

In another general aspect, the invention features a computer network security threat monitoring method for a processor and a storage device including instructions configured to run on the processor. The method includes receiving and storing executable malware binary files, receiving and storing commonly used executable binary files certified as malware free, selecting a subset of the stored executable malware binary files for characterization, iteratively deriving a set of malware identification patterns that are found in successive portions of the selected subset of the stored executable binary files but not in the stored benign executable binary files, and selecting an optimized subset of the detected malware identification patterns, wherein the patterns in the optimized subset together match every one of the selected subset of the stored executable binary files but none of the stored benign executable binary files.

Systems according to the invention can provide the ability to automate the generation of compact sets of malware detection rules that can significantly enhance the speed and efficiency of malware detection, providing critical time savings in the defense against cyber threats.

### BRIEF DESCRIPTION OF THE DRAWING

FIG. 1 is a block diagram of an illustrative cybersecurity system according to the invention;

FIG. 2A is a view of a control panel for the system of FIG. 1;

FIG. 2B is a view of the control panel of FIG. 1 shown after a set of binary malware files has been loaded;

FIG. 2C is a view of the control panel of FIG. 1 with its parameter control expanded after a set of binary malware files has been loaded;

FIG. 2D is a view of the control panel of FIG. 1 shown with patterns loaded and an illustrative pattern filters set;

FIG. 2E is a view of the control panel of FIG. 1 presenting a set of malware binaries matched by a selected set of patterns;

FIG. 2F is a view of the control panel of FIG. 1 showing the type of filters that can be activated when manually hunting for patterns as part of the substring optimization process;

FIG. 2G is a view of the control panel of FIG. 1 showing a set of rules generated by the system;

FIG. 3 is a bipartite graph for an illustrative pattern set; and

FIGS. 4A-4C are a flowchart presenting an overview of a process performed by the illustrative system.

### DETAILED DESCRIPTION OF AN ILLUSTRATIVE EMBODIMENT

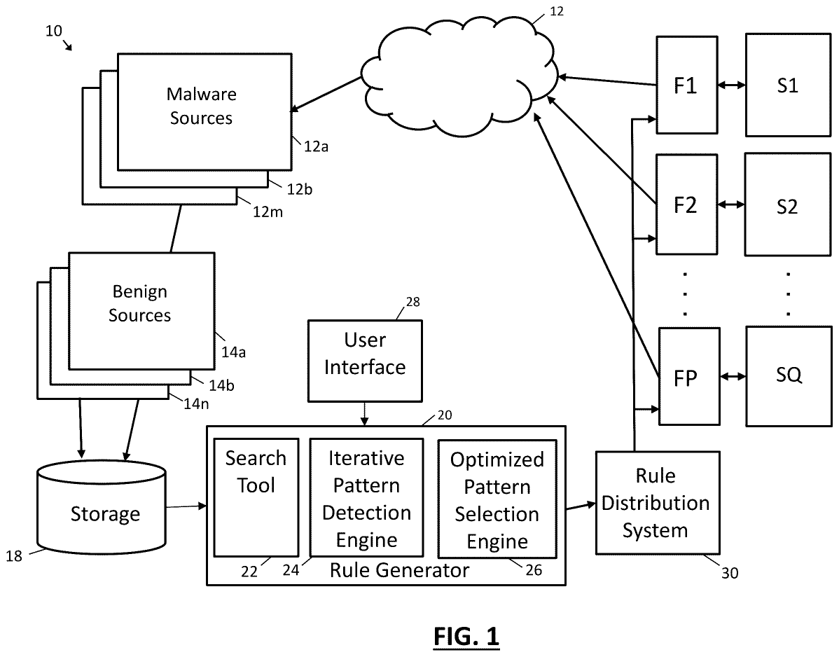

Referring to FIG. 1, an illustrative cybersecurity system 10 according to the invention includes storage 18 with an input to receive malware binary files from one or more malware sources 12a, 12b, . . . 12m, and to receive benign binary files (“goodware”) from one or more benign binary sources 14a, 14b, . . . 14n. The storage can include any type of digital storage, such as disk-based and/or semiconductor-based storage, and it can be organized in a variety of ways ranging from a flat file to a database or file system. The malware files can be tagged with metadata that include fields describing properties such as their source, associated IP addresses and domain names, observed sandbox behavior, and deployment history. The benign files are binary files known to be benign, such as commercially produced executable application files.

The system 10 also includes a rule generator 20 in communication with the storage 18 and having a rule distribution output. The rule generator includes a specialized search tool 22, an iterative pattern detection engine 24, and an optimized pattern selection engine 26. The rule generator can also provide a user interface 28 to allow a user to control and interact with it. The system is in communication with a rule distribution system 30 to deploy the rules to Endpoint Detection Systems (EDSs) such as intrusion detection systems or firewalls F1 . . . FP that protect networked systems S1 . . . SQ. The distribution system can be implemented in a variety of ways to send or make the rules available, ranging from a simple Internet site for openly posting them for retrieval, to a system supporting a secure distribution protocol for transmitting them directly to the endpoint detection systems.

The process of using the system 10 to generate rules begins with assembling a comprehensive set of binaries, typically crowdsourced by a community of threat analysts over several months or even years. Well-known platforms such as Recorded Future's Triage, VirusTotal, and Polyswarm provide access to both public and private submissions of suspicious files. Additionally, malware binaries can be sourced from established malware repositories and other threat intelligence resources.

One way to build a corpus of benign binaries involves checking the National Software Reference Library (NSRL) for hashes of benign files. The NSRL provides a repository of known, traceable software applications, file profiles, and file signatures. Using the hashes obtained from the NSRL, the corresponding benign files can be downloaded from Polyswarm, a marketplace for threat intelligence, which provides access to a wide range of security data and samples.

To create an optimized set of rules that can cover a particular group of malware files, a cybersecurity analyst user begins a process of threat hunting by defining a query in the specialized search tool 22. The defined query identifies a set of malware binaries for which the user would like to generate YARA rules. The search tool allows the analyst to cluster or group malware samples based on static features as well as high-level dynamic features obtained from sandbox runs, such as IP addresses, domain names, and other Indicators of Compromise (IoCs), including behavior patterns. The tool leverages these dynamic analysis features to accurately group similar malware samples, ensuring the collected binaries are relevant to a specific malware strain or family of interest. Traditionally, this process has involved hours or even days of manual analysis to identify commonalities among associated binaries, but this time can be reduced significantly using the specialized search tool.

The iterative pattern selection engine 24 then determines the longest common substrings present in the selected set of malware binaries but absent from the benign binaries, and the optimized pattern generation engine 26 determines the smallest subset of substrings that cover all malware binaries (or as many as possible). This process will be discussed in more detail below and provides a computationally efficient approach to generate specific and effective YARA rules, improving malware detection while reducing the reliance on manual rule creation.

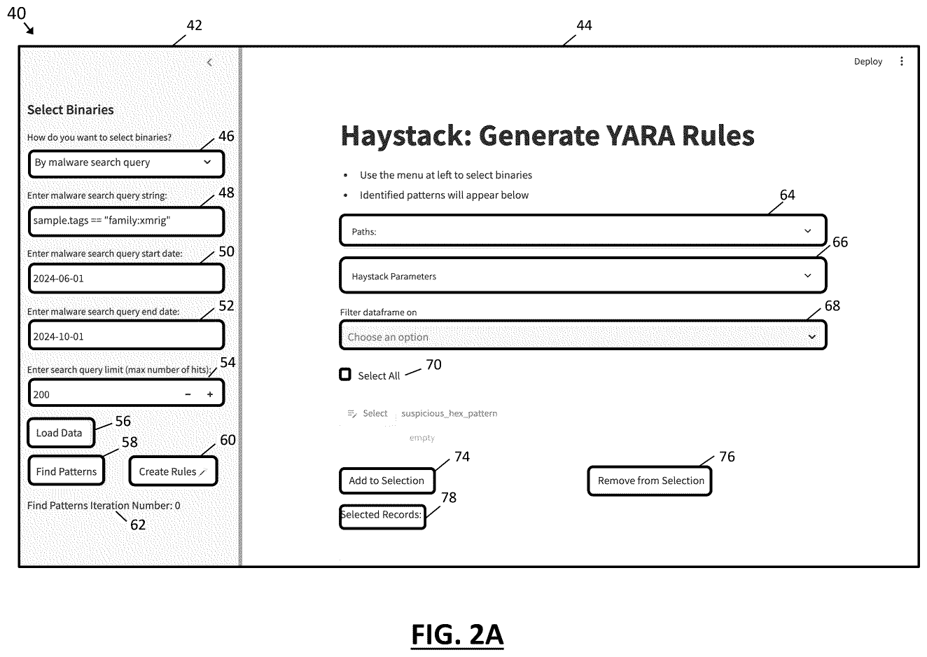

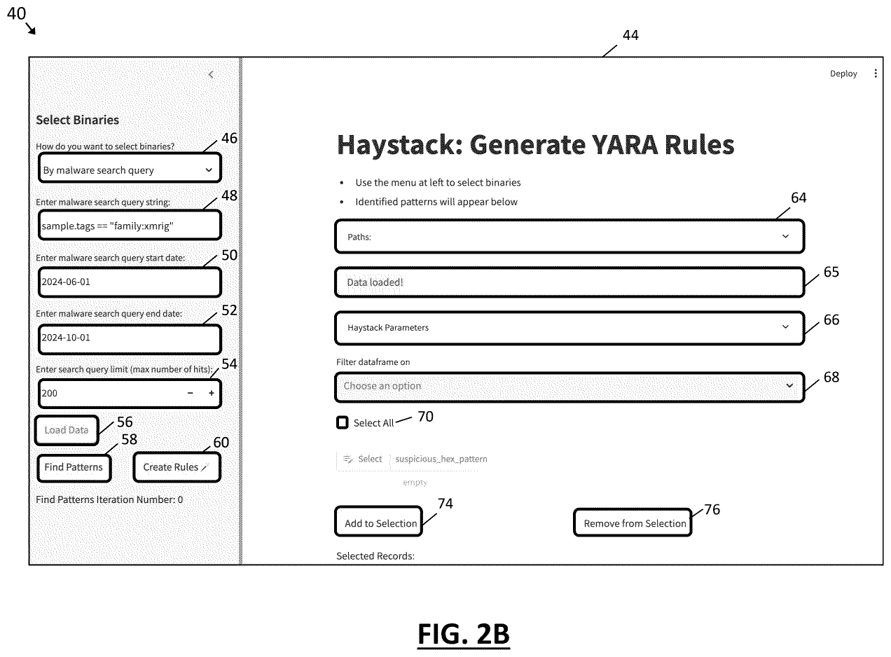

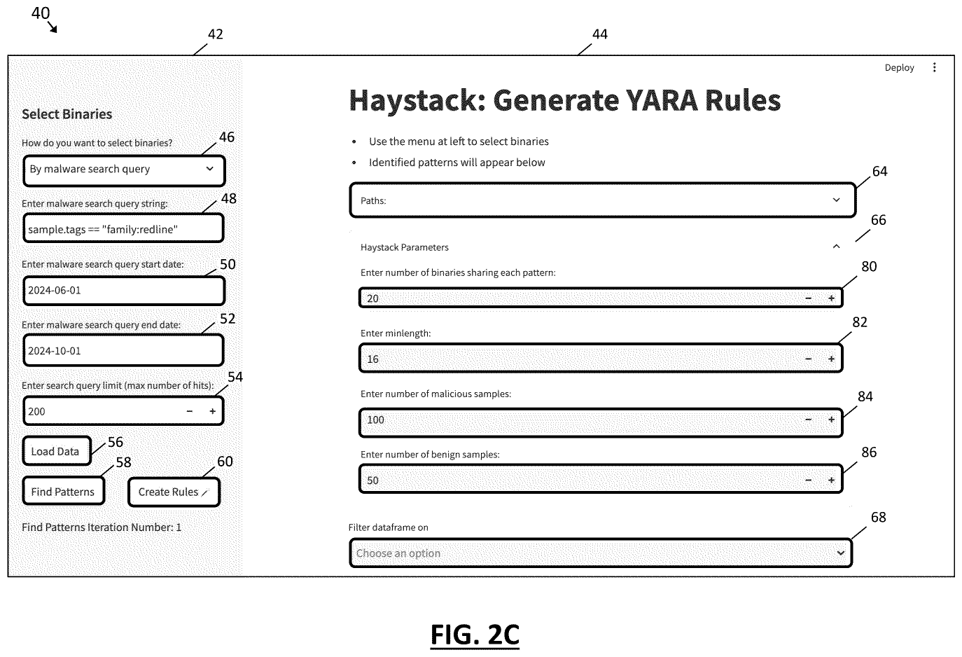

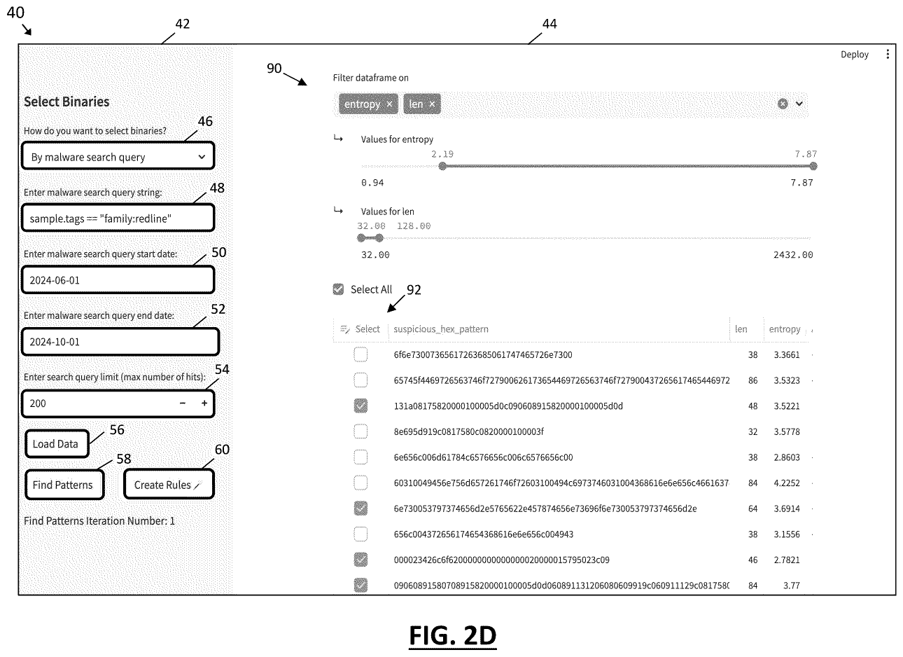

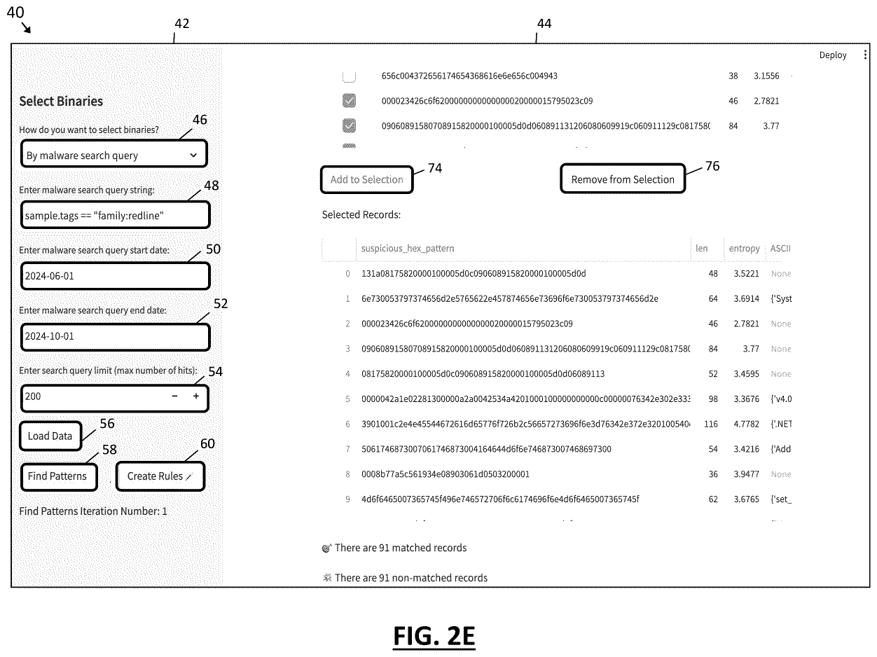

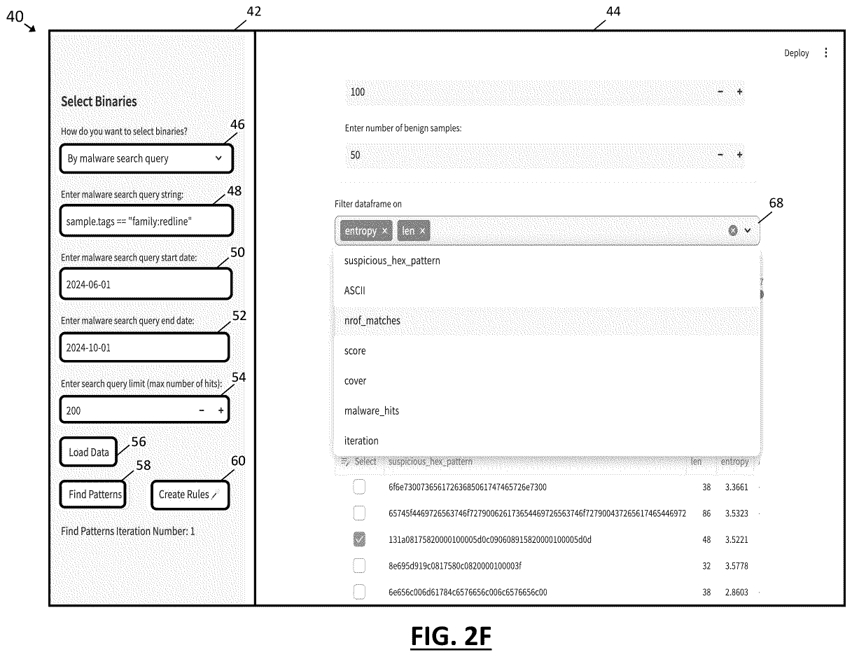

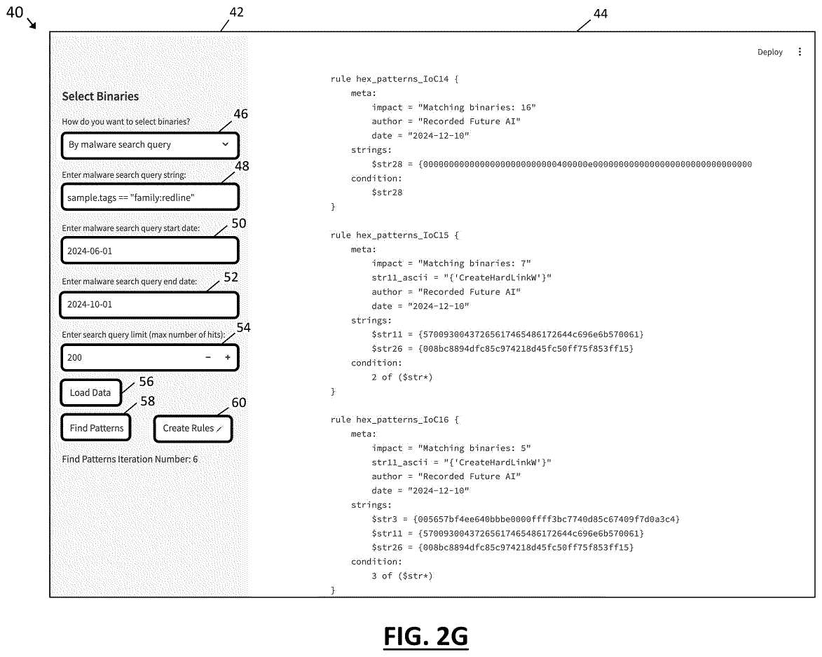

Referring also to FIG. 2A, in one embodiment, the user interface 28 of the cyber security system 10 can present a control panel 40 to a user. This control panel includes a binary selection panel 42 with a selection method control 46, a query string text box 48, start and end date controls 50, 52, a search query limit control 54, a data load control 56, a pattern find control 58, a rule creation control 60, and an iteration count indicator 62.

The control panel 40 also includes a data navigation panel 44. This panel includes a path control 64, a parameter control 66, a filter control 68, a select all control 70, an add to selection control 74, a remove from selection control 76, and a selected records control 78.

The selection method control 46 allows the user to select a search method for the specialized search tool. The user can select to enter a query directly in a specialized query language in the query string text box 48. The user can also select to ask questions in natural language. These questions can then be translated to a formal query.

An example query can be:
“Find all samples that talked http to the netblock 93.184.220.0/24”
which is translated to
“for any flow in dynamic.network.flows:
(flow.layer_7==”http“ and flow.dst_ip==“93.184.220.0/24”)”

Another example query can be
“Find all samples dumping a file matching the regexp
c:\\users.*build.*case insensitively”,
which is translate to
“dynamic.dumped.path matches/c:\\users.*build.*/i”

Some of the available search tags are “IP address”, “destination port”, “first level domain”, “domain”, “URL”, “risk score”, “IP country code”, “ASN”, “TTP”, “signature”, “IoC”, “submitter industry”, “imported DLLs”, “dumped files”, “dumped file paths”, “registry keys read”, “registry keys created”, “registry keys written to”, “PE issuer”, “command lines”.

With a query defined, the user can load the data (the associated binary files), and a confirmation message will reflect this in a message box 65 (see FIG. 2B). Once the data is loaded, the user can select the pattern find control 58 or the rules creation control 60. The rules creation control will then automatically generate the rules.

Referring to FIG. 2C, if the user would instead prefer to hunt for patterns iteratively and manually inspect the partial results, he or she can choose the pattern find control. By then expanding the parameter control 66, the system presents the user with a drop-down menu in which iterative pattern detection parameters can be viewed and set. This menu includes a number of patterns shared control 80, a minimum length control 82, a starting number of malicious samples control 84, and a starting number of benign samples control 86, which are used in the process of iteratively identifying the longest common substrings.

### Identification of Longest Common Substrings

The process of finding patterns can involve an iterative substring identification method that leverages generalized suffix arrays to compute the longest common substrings found in the loaded set of binary files but absent from the benign files. With a time complexity of O(n), where n is the total size of all files, this approach can provide computational efficiency and scalability for processing large datasets.

Although the computational complexity is bounded by O(n), the process of finding incriminating patterns can still be time-intensive. This is because the system searches for all patterns, not just strings of hexadecimal characters interpretable within the ASCII range. To accelerate the process, the system uses an iterative scheme that begins with a smaller, randomly sampled subset of malware and benign binaries from the initial dataset.

For instance, suppose the user aims to find patterns common to 180 malware binaries. Instead of processing all 180 binaries at once, the user can start with a smaller subset of, say, 100 malware binaries, using the sample processing subset control 84. An optimal starting subset size can also be programmatically determined based on file sizes and available computational resources. Once patterns common to this subset are identified, the remaining binaries can be examined to check for overlap with the discovered patterns.

For example, after identifying patterns from the initial 100 binaries, we might find that 50 of the remaining 80 binaries share some of these patterns. This leaves only 30 binaries requiring further analysis. We can then initiate a second iteration, focusing on finding the longest common substrings within this smaller subset of 30 binaries. By progressively narrowing the scope, this iterative approach significantly reduces computational overhead.

A potential complication is that the initial set of malware binaries might not all share a common set of patterns. This depends heavily on how well the query groups similar files. Additionally, two files with similar dynamic behavior may originate from binaries that are fundamentally different—akin to the biological dichotomy of genotype versus phenotype.

To make the computational problem less constrained and increase the likelihood of identifying common patterns, we require that each identified pattern need only be shared by at least k malware binaries within the set. For example, starting with 180 binaries, the user might initially sample 100 of them and set k=20, using the number of patterns shared control 80. This process could yield 40 patterns matching 120 of the 180 binaries. The remaining 60 binaries can then be analyzed in a second iteration. If we attempt to find patterns shared by at least 20 of these remaining 60 binaries, we might not identify any patterns. In such cases, the constraint is too strict, and we can relax it by lowering k to for example 10.

Suppose this adjustment yields two additional patterns, resulting in a total of 42 patterns matching 150 of the original 180 binaries. This leaves 30 binaries for which no patterns have yet been found. As a heuristic, we can halve k in subsequent iterations, unless k reaches a small value such as 5. At that point, we might decrement k by 1 per iteration instead.

Continuing with the example, we could try finding common patterns among the remaining 30 binaries with k=5. With such a relaxed constraint, we might discover as many as 200 additional patterns. This would bring the total to 242 patterns, perhaps covering 170 of the initial 180 binaries.

We require k≥2 in all iterations because a pattern should be shared by at least two binaries to qualify as a valid common substring. From experimentation, we have found that a single iteration is often sufficient to identify patterns that encompass all binaries in our malware set. At the other extreme, we may encounter patterns present in all but one malware binary. In such cases, the default pattern for the isolated binary becomes its exact file hash (e.g., its SHA256 hash). Additionally, we may choose to stop the iterative process after a predefined maximum number of iterations or when a substantial fraction of the malware binaries have been matched.

As described, each search uses a set of benign binaries as a negative set. Any discovered pattern found in this set is rejected. To reduce computational overhead, the user can initially limit the negative set to a small subset of benign binaries (e.g., 50), using the minimum length control 82. Once candidate patterns are identified, they can be validated against a much larger repository of benign binaries. The Aho-Corasick algorithm could be used for this purpose. However, its time complexity scales linearly with the length of the corpus being scanned. Ideally, we would prefer to use a massive set of benign binaries to minimize the risk of identifying false-positive patterns—those present in both benign files and malware, which cannot serve as incriminating evidence.

To address this, we employ an FM-index, a compressed full-text substring index based on the Burrows-Wheeler transform, as proposed by Paolo Ferragina and Giovanni Manzini. This technique, widely used in bioinformatics, limits the time complexity of filtering out false positives to the length of each search string (i.e., each pattern) rather than the size of the corpus.

Finally, we account for the complication posed by packers (e.g., zip, rar). Since malware binaries are often compressed for obfuscation, they should be unpacked before we attempt to identify common patterns. Failing to do so risks identifying patterns that are merely artifacts of the employed packer—patterns that could also appear in packed benign binaries. To mitigate this, we advocate for dynamic analysis, where compressed files are unzipped before execution and analysis, granting access to the raw binaries.

Referring to FIG. 2D, once the suffix-array based algorithm has found candidate patterns, they are shown in the data navigation panel 44. From there, the user can filter patterns based on length (in number of characters), entropy, regular expressions to match any embedded ASCII substrings, etc. using filter controls 90. In the illustrative data shown in the figure, the user has chosen to filter on length and entropy (32<length<128 and entropy>2.19). The user can then select all patterns matching these search filters by clicking the select all control 70. The user can also manually pick a subset of patterns from the filtered ones using selection checkboxes 92 provided for each pattern.

Once the user is satisfied with his or her selection of patterns, the user can click on the add to selection button 74 to compile a set of rules based on these patterns, as shown in FIG. 2E. In this example, the system matches 91 malware binaries with this selection of patterns. The user can also remove patterns from the selection at this stage using the remove from selection control 76.

FIG. 2F shows the type of filters that can be activated when manually hunting for patterns as part of the substring optimization process. The user can match regex patterns in any embedded ASCII substrings, filter on the number of matching binaries, specify a heuristic score, specify whether or not the pattern is essential to match the binaries (where essential is defined as being part of the bipartite graph cover), specify a number of matching malware binaries from a bigger collection of common malware, and specify an iteration number as explained in more detail below. After any iteration, the user can keep searching, or export rules. Unmatched binaries will be caught by generating filehash-based YARA rules. An AI-based system (for example, leveraging a large language model) may also be used to assess extracted patterns and determine whether they are indicative of malicious intent.

Typically, the user will seek to work with the controls until there are no (or very few) filehash-based rules. Once the rules are generated, they are displayed in the navigation panel 44 (see FIG. 2G), and the user can scroll through them to see them all. Some meta data, such as embedded ASCII (if any), is also written to each rule. The rules are exported to a file which can directly be integrated in an EDR tool.

### Substring Optimization

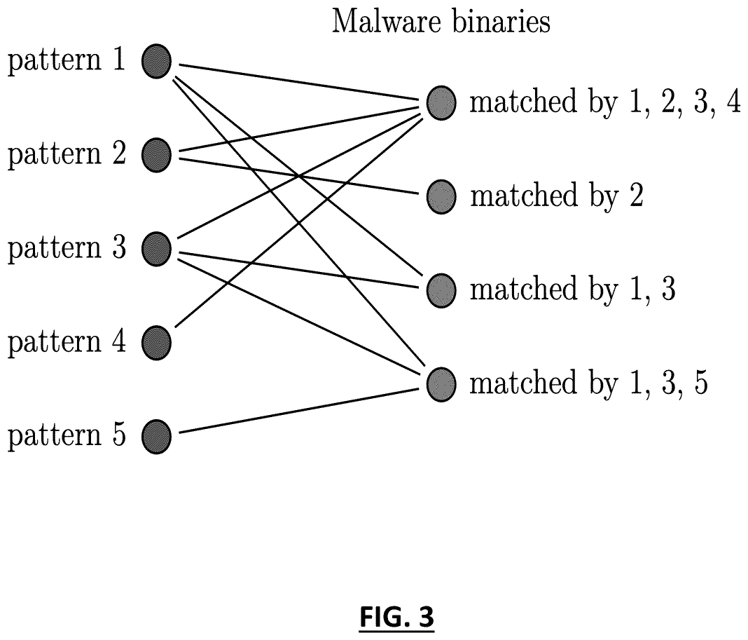

Referring to FIG. 3, once patterns have been identified that match all malware binaries, the ultimate goal is to compile an efficient and robust set of YARA rules based on these patterns. However, not all patterns may be necessary to cover all binaries effectively.

To optimize the rule set, we can assign heuristic scores to the patterns. For instance, patterns with very low entropy and overly long patterns might be penalized. Patterns that match a larger number of binaries could be promoted over those matching fewer binaries. If explainability is important, we might also favor patterns containing ASCII-readable substrings.

Additionally, we can represent this optimization problem using a bipartite graph, where one set of nodes corresponds to patterns and the other to binary files, as shown in FIG. 3. An edge exists between a substring node and a malware binary node if the substring is present in the binary. Using an efficient heuristic approach, we can identify a subset of pattern nodes that collectively match all file nodes. This involves iterating through pattern nodes in decreasing order of cost-effectiveness and selecting them until all file nodes are covered. This method allows us to compile an effective set of YARA rules, consisting of a minimal yet sufficient subset of patterns to match all malware binaries.

Each pattern (hex string) would then be converted into an atomic YARA rule. While such rules might seem brittle, recall that every pattern is present in at least k malware binaries. If the process involves multiple iterations, k may decrease as the process progresses, making some rules less robust than others. This is expected, and in extreme cases, the resulting rule could be a simple file hash. Although file hash rules are less effective against polymorphic malware, they are not inherently harmful, as they have been verified to avoid triggering on benign files.

A fully automated system can also be developed where this process forms the core. This system can set the parameters based on file sizes, system resources, and other variables, and machine learning could even be applied to optimize the parameters. This could allow new rules to be automatically generated and distributed every few minutes, enabling the system to quickly adapt to polymorphic malware strains as they emerge in the wild.

To improve robustness, we propose further analyzing the cover set. Patterns essential for achieving coverage should be prioritized. For instance, in the example illustrated in FIG. 1, pattern 2 is necessary to match the second binary node. However, pattern 2 also matches the first binary. For the remaining binaries (corresponding to the third and fourth nodes), we aim to select the longest common subsequence of patterns, which in this case are pattern 1 and pattern 3.

As a result, we can generate an atomic rule based on pattern 2 and a composite rule requiring both pattern 1 and pattern 3 to be present for activation. Notably, this second rule would trigger not only for the bottom two binaries in the example but also for the topmost binary. This multiplicity can be included as meta-information in the rule. For example, the multiplicity of the first atomic rule (pattern 2) is 2, while the multiplicity of the second composite rule (patterns 1 and 3) is 3, reflecting the number of binaries each rule captures in the initial search space.

### Process Overview

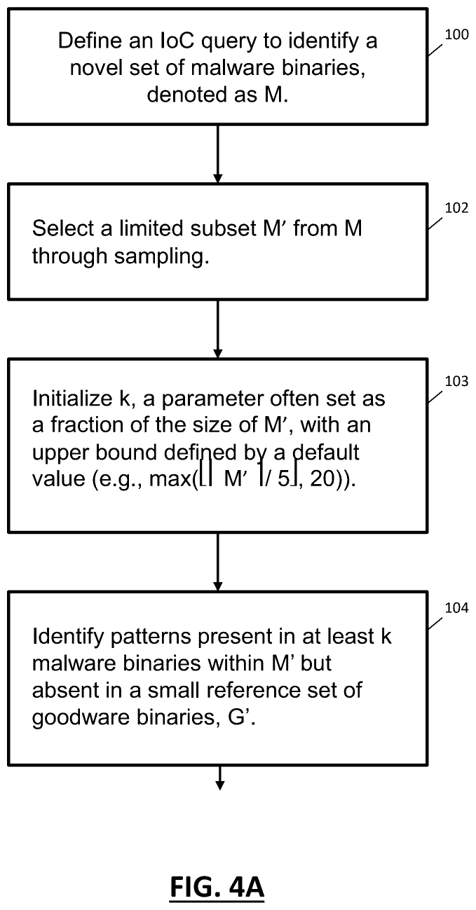

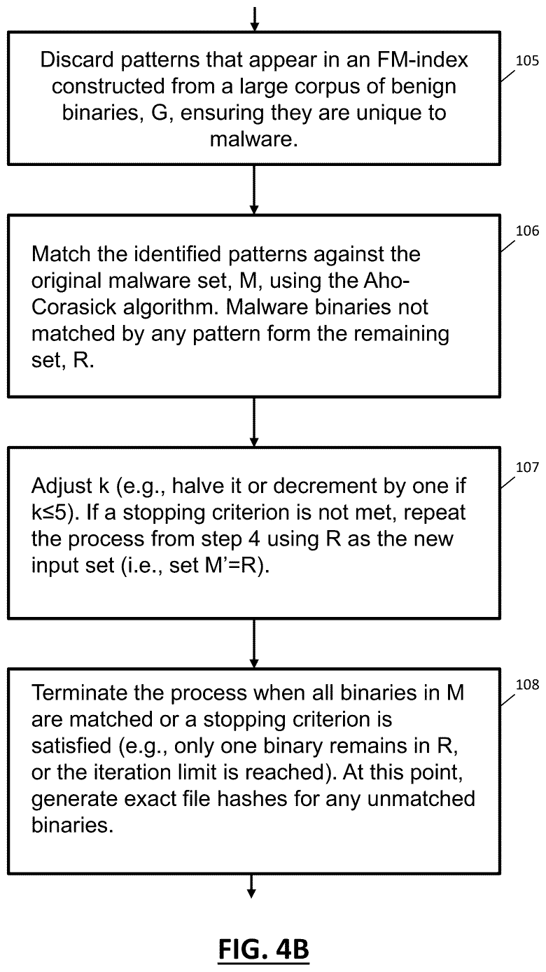

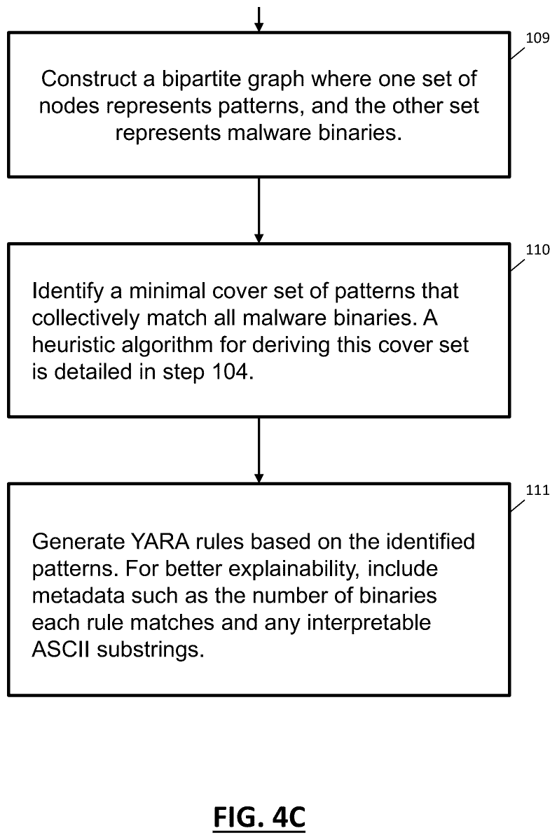

An overview of the process performed by the illustrative system 10 is outlined in a series of steps shown in FIGS. 4A-4C. The first eight steps (101-108) present an implementation of the process of detecting longest common substrings. The last three steps (109-111) present an implementation of the process of substring optimization.

Referring to FIG. 4A, this process begins by defining an IoC query to identify a novel set of malware binaries, denoted as M (step 101). A limited subset M′ is then selected from M through sampling (step 102). The size of this subset is a hyperparameter, typically influenced by file sizes and available computational resources. k, a parameter often set as a fraction of the size of M', is initialized with an upper bound defined by a default value (e.g., max(└|M′|/5┘, 20)) (step 103). Patterns present in at least k malware binaries within M′ but absent in a small reference set of goodware binaries, G′ are identified (step 104). This can be efficiently achieved using generalized suffix arrays.

Referring to FIG. 4B, patterns that appear in an FM-index constructed from a large corpus of goodware binaries are discarded, G, ensuring they are unique to malware (step 105). The identified patterns are matched against the original malware set, M, using the Aho-Corasick algorithm. Malware binaries not matched by any pattern form the remaining set, R (step 106). k is then adjusted (e.g., halved or decremented by one if k≤5). If a stopping criterion is not met, the process is repeated from step 4 using R as the new input set (i.e., set M′=R) (step 107). The process is terminated when all binaries in M are matched or a stopping criterion is satisfied (e.g., only one binary remains in R, or the iteration limit is reached). At this point, generate exact file hashes for any unmatched binaries (step 108).

Referring to FIG. 4C, the process of substring optimization begins with the construction of a bipartite graph, where one set of nodes represents patterns, and the other set represents malware binaries (step 109). A minimal cover set of patterns that collectively match all malware binaries is identified. A heuristic algorithm for deriving this cover set is detailed in step 104 (step 110). YARA rules are generated based on the identified patterns. For better explainability, metadata such as the number of binaries each rule matches and any interpretable ASCII substrings are included (step 111).

The above process is typically accelerated by limiting the search in each iteration to patterns whose length exceeds a given threshold (such as patterns with at least 16 characters). We make sure that patterns that are substrings of other patterns are also rejected in this process. Finally, we can cap the search such that it only emits at most N patterns (per iteration).

The system described above could be implemented in a variety of other ways. The user interface is implemented so that it can be accessed with a standard web browser, but it could be configured differently, with different types of controls, selections of controls, and default starting values. Parts of the system, such as the search tool, pattern detection engine, and optimized pattern selection engine could also be implemented as separate systems having their own user interfaces. Some or all of the functions can be automated to increase response time, as noted above. And while YARA rules are the presently preferred format to detect malware, pattern sets could produce output that conforms to other standards.

The system described above, including the search tool, pattern detection engine, and optimized pattern selection engine, has been implemented in connection with digital logic, storage, and other elements embodied in special-purpose software running on a general-purpose computer platform. Systems of this type may be built using development systems targeted to Unix/Linux, Windows, macOS, or other platforms, but they could also be implemented in whole or in part using virtualized platforms and/or special-purpose hardware. C++ was found to be well suited to developing the embodiments described above but other languages could be used as well. And while the system can be broken into the series of modules and steps shown in the various figures for illustration purposes, one of ordinary skill in the art would recognize that it is also possible to combine them and/or split them differently to achieve a different breakdown.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A computer network security threat characterization system, including:
malware binary storage operative to receive and store executable malware binary files,
benign binary storage operative to receive and store commonly used executable binary files certified as malware free,
a search tool operative to access the malware binary storage and to select a subset of the stored executable malware binary files for characterization,
an iterative pattern detection engine responsive to the search tool, malware binary storage, benign binary storage, and operative to iteratively derive a set of malware identification patterns that are found in successive portions of the selected subset of the stored executable binary files but not in the stored benign executable binary files, and
an optimized pattern selection engine operative to select an optimized subset of the malware identification patterns detected by the iterative pattern detection engine, wherein the patterns in the optimized subset together match every one of the selected subset of the stored executable binary files but none of the stored benign executable binary files.

2. The system of claim 1 wherein the iterative pattern detection engine is operative to iteratively detect the patterns by first detecting patterns in one of the portions of the subset (m) of the malware files and then applying the detected patterns in the subset of malware files to remaining malware files in the selected subset of the malware files.

3. The system of claim 2 wherein the iterative pattern detection engine is operative to find patterns that only match an iteratively adjustable number (k) of the malware binary files.

4. The system of claim 1 wherein the iterative pattern detection engine is operative to iteratively detect the patterns by first detecting patterns in a subset of the benign files and then applying the detected patterns to remaining benign files.

5. The system of claim 1 wherein the iterative pattern detection engine is operative to iteratively derive the set of malware identification patterns based on generalized suffix arrays.

6. The system of claim 1 wherein the search tool includes a user engine including selection controls allowing the user to specify a search query.

7. The system of claim 6 further including iteration parameter controls responsive to user input to specify iteration parameters for the iterative pattern detection engine.

8. The system of claim 6 wherein the search tool is operative to generate queries that match dynamic and static features of the malware binary files.

9. The system of claim 8 wherein the search tool is also operative to generate queries that match a source of the malware binary files.

10. The system of claim 1 further including an automatic iteration parameter control that is operative to specify iteration parameters for the iterative pattern detection engine based at least on a measure of size of the selected subset of malware executable binary files.

11. The system of claim 1 further including a rule formatter to convert the optimized subset of the malware identification patterns into rules for deployment to endpoint protection systems.

12. The system of claim 11 wherein the rule formatter is a YARA rule formatter.

13. The system of claim 1 wherein the optimized pattern selection engine is operative to iteratively optimize pattern selection using a bipartite graph.

14. The system of claim 13 wherein the optimized pattern selection engine employs cost-effectiveness heuristics to optimize pattern selection.

15. The system of claim 14 wherein the cost-effectiveness heuristics include at least measures of pattern length, entropy, and character content.

16. The system of claim 1 further including an unpacking engine operative to unpack the stored malware binaries before processing by the iterative pattern detection engine.

17. The system of claim 1 further including a rule distribution subsystem operative to distribute the optimized subset of the malware identification patterns selected by the optimized pattern selection engine.

18. The system of claim 1 further including an AI-based system to assess extracted patterns and determine whether they are indicative of malicious intent.

19. A computer network security threat monitoring method for a processor and a storage device including instructions configured to run on the processor, including:
receiving and storing executable malware binary files,
receiving and storing commonly used executable binary files certified as malware free,
selecting a subset of the stored executable malware binary files for characterization,
iteratively deriving a set of malware identification patterns that are found in successive portions of the selected subset of the stored executable binary files but not in the stored benign executable binary files, and
selecting an optimized subset of the detected malware identification patterns, wherein the patterns in the optimized subset together match every one of the selected subset of the stored executable binary files but none of the stored benign executable binary files.
